(19) United States
(12) Patent Application Publication
(10) Pub. No.: US 2014/0153154 A1
(43) Pub. Date: Jun. 5, 2014

(54) MULTI-LAYERED CERAMIC ELECTRONIC COMPONENT

(71) Applicant: SAMSUNG ELECTRO-MECHANICS CO., LTD., Suwon (KR)

(72) Inventors: Sung Hyuk CHOI, Suwon (KR); Byung Kwon YOON, Suwon (KR); Sang Hyuk KIM, Suwon (KR)

(73) Assignee: SAMSUNG ELECTRO-MECHANICS CO., LTD., Suwon (KR)

(21) Appl. No.: 13/724,253

(22) Filed: Dec. 21, 2012

(30) Foreign Application Priority Data
Dec. 4, 2012 (KR) 10-2012-0139625

(51) Int. Cl. H01G 4/30

(52) U.S. Cl. CPC H01G 4/30
USPC 361/301.4

(57) ABSTRACT

There is provided a multi-layered ceramic electronic component including: a ceramic body including a dielectric layer and having first and second main surfaces, first and second side surfaces, and first and second end surfaces; a first internal electrode having an overlapping region to form a capacitance formation part and exposed to the first and second side surfaces, and including a first lead-out part; a second internal electrode alternately multi-layered with the first internal electrode to be exposed to the first and second side surfaces, and insulated from the first internal electrode, and including the second lead-out part; first and second external electrodes; and insulation layers formed on the first and second side surfaces, the first and second lead-out parts being regions in which the first and second internal electrodes are not overlapped with each other.

### CROSS-REFERENCE TO RELATED APPLICATIONS

This application claims the priority of Korean Patent Application No. 10-2012-0139625 filed on Dec. 4, 2012, in the Korean Intellectual Property Office, the disclosure of which is incorporated herein by reference.

### BACKGROUND OF THE INVENTION

1. Field of the Invention

The present invention relates to a multi-layered ceramic electronic component capable of reducing short circuit defects between internal electrodes and acoustic noise generated in the multi-layered ceramic electronic component when voltage is applied thereto.

2. Description of the Related Art

Examples of electronic components using a ceramic material include a capacitor, an inductor, a piezoelectric material, a varistor, thermistor, or the like.

Among these ceramic electronic components, a multi-layered ceramic capacitor (MLCC) has advantages such as small size, high capacitance, ease of mounting, and the like.

Multi-layered ceramic capacitors are chip-type condensers mounted on the circuit boards of various electronic products such as computers, personal digital assistants (PDAs), and cellular phones, performing an important role in charging and discharging electricity, and have various sizes and multi-layered forms, according to intended use and capacity.

Particularly, recently, in accordance with the miniaturization of electronic product, providing multi-layered ceramic capacitors used in electronic products with a subminiature size and ultra high capacitance has been demanded.

Therefore, multi-layered ceramic capacitors in which thicknesses of the dielectric layers and internal electrodes are thinned for the micro-miniaturization of electronic products and in which a relatively large number of dielectric layers are stacked for super high capacitance have been manufactured.

Meanwhile, in the case of a multi-layered ceramic capacitor having a structure in which all external electrodes are positioned on a lower surface, such a multi-layered ceramic capacitor has excellent mounting density and capacitance and low equivalent series inductance (ESL), but short circuit defects between internal electrodes by a pushing phenomenon of the internal electrodes facing each other due to cutting stress generated at the time of cutting a ceramic body may be easily generated.

### RELATED ART DOCUMENT

Japanese Patent Laid-Open Publication No. 2006-086359

### SUMMARY OF THE INVENTION

An aspect of the present invention provides a multi-layered ceramic electronic component capable of reducing short circuit defects between internal electrodes and acoustic noise generated in the multi-layered ceramic electronic component when voltage is applied thereto.

According to an aspect of the present invention, there is provided a multi-layered ceramic electronic component including: a ceramic body including a dielectric layer and having first and second main surfaces opposing each other, first and second side surfaces opposing each other, and first and second end surfaces opposing each other; a first internal electrode having an overlapping region provided in the ceramic body so as to form a capacitance formation part and exposed to the first and second side surfaces and a first lead-out part extended from the capacitance part so as to be exposed to the second side surface; a second internal electrode alternately multi-layered with the first internal electrode so as to be exposed to the first and second side surfaces, having the dielectric layer therebetween, and insulated from the first internal electrode, and including the second lead-out part extended from the capacitance part so as to be exposed to the first side surface; first and second external electrodes connected to the first and second lead-out parts, respectively; and insulation layers formed on the first and second side surfaces of the ceramic body, wherein the first and second lead-out parts are regions in which the first and second internal electrodes are not overlapped with each other.

When a length of the ceramic body in a length direction is defined as L, and a width of a margin part corresponding to a region in which the internal electrode is not formed, in the length direction of the ceramic body is defined as Lm, 0.03≦Lm/L≦0.2 may be satisfied.

When a length of the ceramic body in a length direction is defined as L, and a length of a non-overlapping region in the length direction of the ceramic body is defined as Lc, 0.05—Lc/L≦0.4 may be satisfied.

When a width of the ceramic body in a width direction is defined as W, and a width of a non-overlapping region in the width direction of the ceramic body is defined as Wc, 0.05≦Wc/W≦0.5 may be satisfied.

The first external electrode may be extended to at least one of the first main surface, the second main surface, and the first side surface of the ceramic body.

The second external electrode may be extended to at least one of the first main surface, the second main surface, and the second side surface of the ceramic body.

The insulation layer may include at least one selected from a group consisting of an epoxy, a heat resistant polymer, glass, and a ceramic.

The insulation layer may cover the entire exposed portions of the first and second internal electrodes overlapped with each other.

The insulation layer may have a thickness lower than those of the first and second external electrodes measured from the first side surface of the ceramic body.

According to another aspect of the present invention, there is provided a multi-layered ceramic electronic component including: a ceramic body including a dielectric layer and having first and second main surfaces opposing each other, first and second side surfaces opposing each other, and first and second end surfaces opposing each other; a first internal electrode having an overlapping region provided in the ceramic body so as to form a capacitance formation part, exposed to the first and second side surfaces, and spaced apart from the first and second end surfaces by a predetermined interval, and including a first lead-out part extended from the capacitance part so as to be exposed to the second side surface; a second internal electrode alternately multi-layered with the first internal electrode, having the dielectric layer therebetween, exposed to the first and second side surfaces, spaced apart from the first and second end surfaces by a predetermined interval, and insulated from the first internal electrode, and including a second lead-out part extended from the capacitance part so as to be exposed to the first side surface; a first external electrode connected to the first lead-out part and formed on the first main surface and the second side surface and a second external electrode connected to the second lead-out part and formed on the first main surface and the first side surface; and insulation layers formed on the first and second side surfaces of the ceramic body, wherein the first and second lead-out parts are regions in which the first and second internal electrodes are not overlapped with each other.

When a length of the ceramic body in a length direction is defined as L, and a width of a margin part corresponding to a region in which the internal electrode is not formed, in the length direction of the ceramic body is defined as Lm, 0.03≦Lm/L≦0.2 may be satisfied.

When a length of the ceramic body in the length direction is defined as L, and a length of a non-overlapping region in the length direction of the ceramic body is defined as Lc, 0.05≦Lc/L≦0.4 may be satisfied.

When a width of the ceramic body in a width direction is defined as W, and a width of a non-overlapping region in the width direction of the ceramic body is defined as Wc, 0.05≦Lc/W≦0.5 may be satisfied.

The insulation layer may include at least one selected from a group consisting of an epoxy, a heat resistant polymer, glass, and a ceramic.

The insulation layer may cover the entire exposed portions of the first and second internal electrodes.

The insulation layer may have a thickness lower than those of the first and second external electrodes measured from the first side surface of the ceramic body.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view showing a schematic structure of a multi-layered ceramic capacitor according to an embodiment of the present invention;

FIG. 2 is an exploded perspective view of FIG. 1;

FIG. 3 is a cross-sectional view showing a structure in which a first internal electrode and a first external electrode of FIG. 1 are coupled to each other;

FIG. 4 is a cross-sectional view showing a structure in which a second internal electrode and a second external electrode of FIG. 1 are coupled to each other;

FIG. 5 is a cross-sectional view showing a structure in which the first and second internal electrodes and the first and second external electrodes of FIG. 1 are coupled to each other; and

FIG. 6 is a schematic view schematically showing an internal structure of the multi-layered ceramic capacitor when viewed from a first side of FIG. 1.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

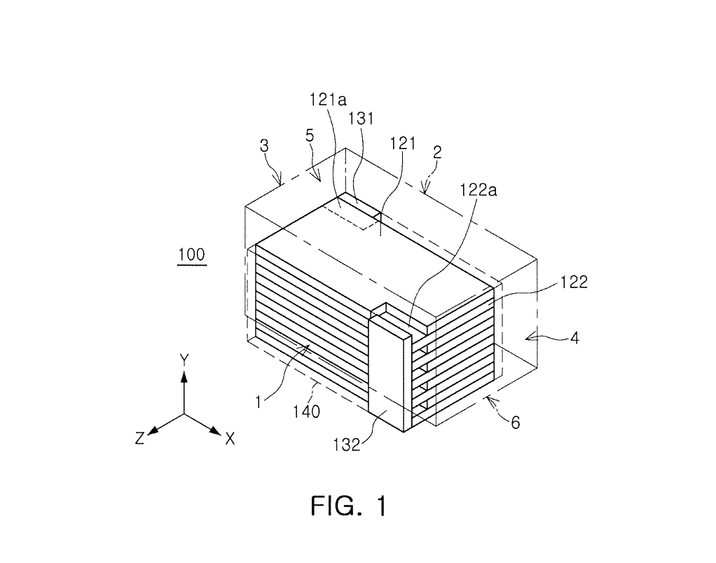

FIG. 1 is a perspective view showing a schematic structure of a multi-layered ceramic capacitor according to an embodiment of the present invention.

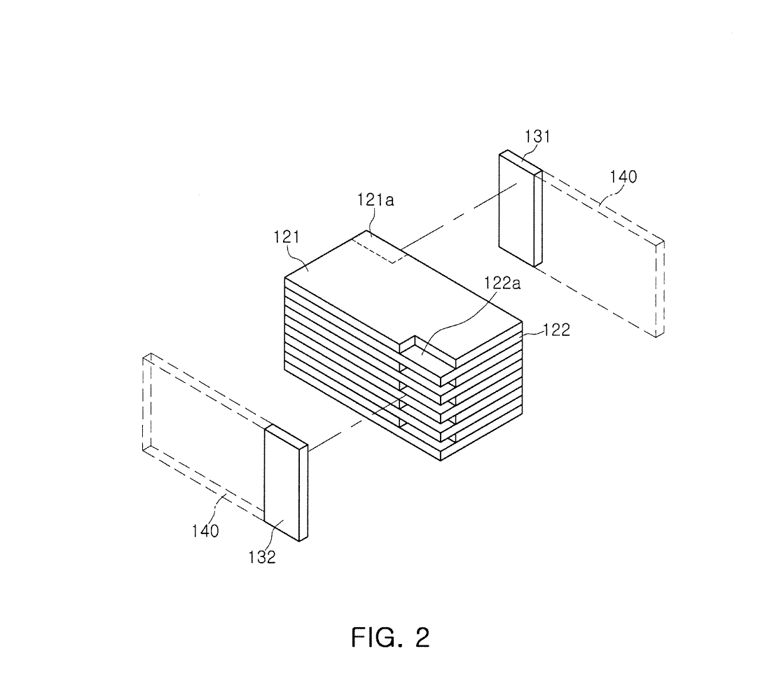

FIG. 2 is an exploded perspective view of FIG. 1.

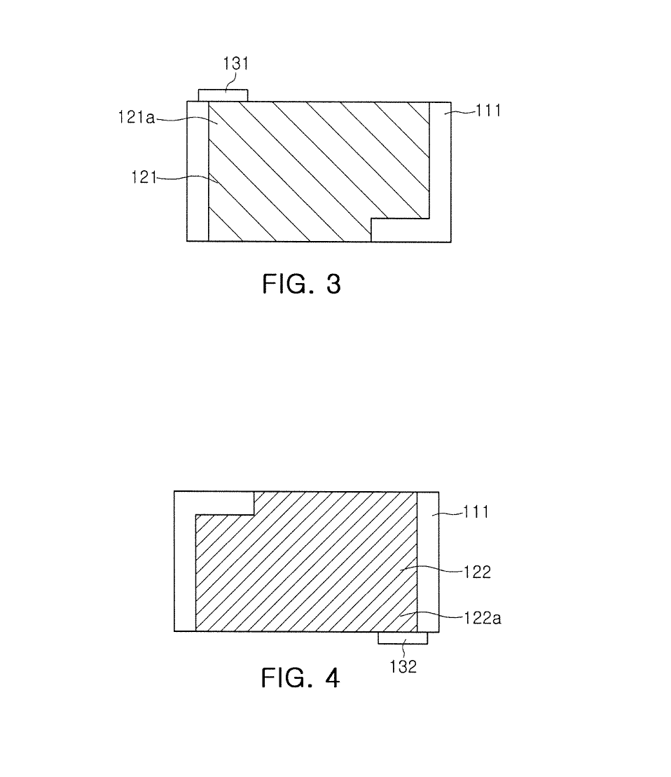

FIG. 3 is a cross-sectional view showing a structure in which a first internal electrode and a first external electrode of FIG. 1 are coupled to each other.

FIG. 4 is a cross-sectional view showing a structure in which a second internal electrode and a second external electrode of FIG. 1 are coupled to each other.

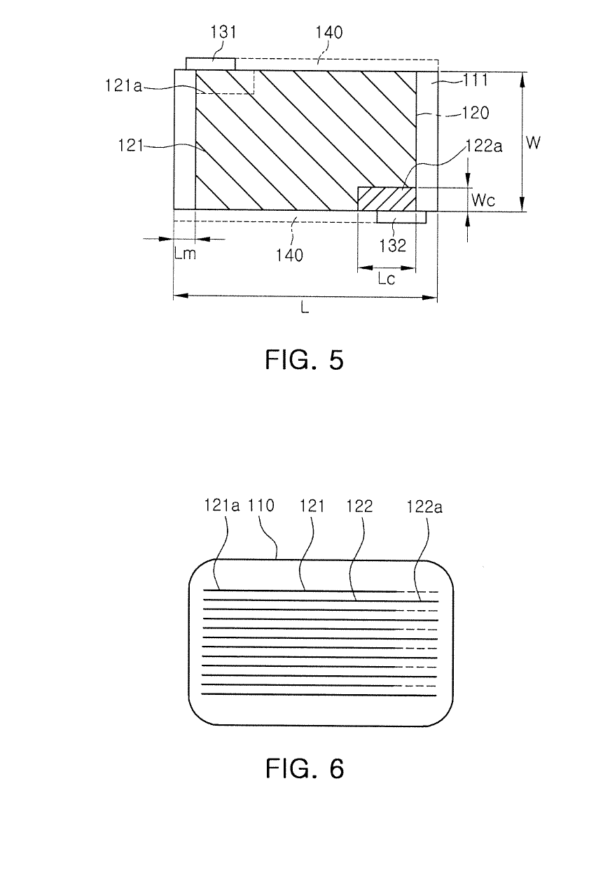

FIG. 5 is a cross-sectional view showing a structure in which the first and second internal electrodes and the first and second external electrodes of FIG. 1 are coupled to each other.

FIG. 6 is a schematic view schematically showing an internal structure of the multi-layered ceramic capacitor when viewed from a first side of FIG. 1.

Referring to FIGS. 1 through 6, the multi-layered ceramic capacitor 100 according to the embodiment of the present invention may include a ceramic body 110; internal electrodes 121 and 122 formed in the ceramic body; and an insulation layer 140 and an external electrode 131 or 132 formed on one surface of the ceramic body.

According to the present embodiment, the ceramic body 110 may have first and second main surfaces 5 and 6 opposing each other, and first and second side surfaces 1 and 2 and first and second end surfaces 3 and 4 that connect the first and second main surfaces 5 and 6 to each other. A shape of the ceramic body is not particularly limited, but may be hexahedral, as shown. According to the embodiment of the present invention, the first main surface 5 of the ceramic body may be a mounting surface disposed in a mounting region of a circuit board.

According to the embodiment of the present invention, an x-direction, a length direction of the ceramic body, refers to a direction in which first and second external electrodes are formed, having a predetermined interval therebetween, a y-direction, a thickness direction of the ceramic body, refers to a direction in which the internal electrodes are stacked, having a dielectric layer therebetween, and a z-direction refers to a width direction of the ceramic body.

According to the embodiment of the present invention, the y-direction may be a direction in which the internal electrodes are mounted on the circuit board.

According to the embodiment of the present invention, the ceramic body 110 may be formed by stacking a plurality of dielectric layers 111. The plurality of dielectric layers 111 configuring the ceramic body 110 maybe in a sintered state and be integrated with each other so as not to confirm a boundary between dielectric layers adjacent to each other.

The dielectric layer 111 may be formed by firing a ceramic green sheet including a ceramic powder, an organic solvent, and an organic binder. As the ceramic powder, a high k material, a barium titanate (BaTiO3) based material, a strontium titanate (SrTiO3) based material, or the like, may be used. However, the ceramic powder is not limited thereto.

According to the embodiment of the present invention, the ceramic body 110 may include the internal electrodes formed therein.

Referring to FIGS. 3 through 5, the first internal electrode 121 having a first polarity and the second internal electrode 122 having a second polarity may be formed in a pair and be disposed in the y-direction so as to face each other, having the dielectric layer 111 therebetween.

According to the embodiment of the present invention, the first and second internal electrodes 121 and 122 may be disposed horizontally to the mounting surface, that is, the first main surface 5, of the multi-layered ceramic capacitor.

In the embodiment of the present invention, the first and second polarities may refer to different polarities.

According to the embodiment of the present invention, the first and second internal electrodes 121 and 122 may be formed of a conductive paste including a conductive metal.

The conductive metal may be nickel (Ni), copper (Cu), palladium (Pd), or an alloy thereof, but is not limited thereto.

An internal electrode layer may be printed on a ceramic green sheet configuring the dielectric layer by using a conductive paste through a printing method such as a screen printing method or a gravure printing method.

The ceramic green sheets having the internal electrode layer printed thereon may be alternately multi-layered and fired to form the ceramic body.

The multi-layered ceramic capacitor 100 according to the embodiment of the present invention may include the first internal electrode 121 having an overlapping region provided in the ceramic body 110 so as to form a capacitance part 120 forming capacitance and exposed to the first and second side surfaces 1 and 2 and a first lead-out part 121a extended from the capacitance part 120 so as to be exposed to the second side surface 2; and the second internal electrode 122 alternately multi-layered with the first internal electrode 121 so as to be exposed to the first and second side surfaces 1 and 2, having the dielectric layer 111 therebetween, insulated from the first internal electrode 121, and including the second lead-out part 122a extended from the capacitance part 120 so as to be exposed to the first side surface 1.

The first and second internal electrodes 121 and 122 have first and second lead-out parts 121a and 122a, respectively, so as to be connected to the external electrodes having different polarities, wherein the first lead-out part 121a may be exposed to the second side surface 2 of the ceramic body 110, and the second lead-out part 122a may be exposed to the first side surface 1 of thereof.

According to the embodiment of the present invention, the lead-out part of the internal electrode may indicate a region in which a conductor pattern forming the internal electrode has an increased width W to thereby be exposed to one surface of the ceramic body.

The first and second internal electrodes 121 and 122 may form capacitance in an overlapping region thereof, and the first and second lead-out parts 121a and 122a connected to the external electrodes having different polarities do not have an overlapping region.

As described above, since the first and second lead-out parts 121a and 122a are not overlapped with each other but insulated from each other, short circuit defects between internal electrodes by a pushing phenomenon of the internal electrodes opposing each other due to cutting stress at the time of cutting a ceramic body may be reduced.

According to the embodiment of the present invention, the first lead-out part 121a may be exposed to the second side surface 2 of the ceramic body 110, and the second lead-out part 122a may be exposed to the first side surface 1 thereof.

Since the first and second lead-out parts 121a and 122a are not overlapped with each other but exposed to the second and first side surfaces of the ceramic body, respectively, step sections formed in two directions in the related art may be changed to step sections formed in one direction, such that short circuit defects between the internal electrodes may be reduced.

That is, the pushing phenomenon of the internal electrodes opposing each other caused by cutting stress at the time of cutting the ceramic body is reduced, such that short circuit defects between the internal electrodes may be reduced.

In addition, the first and second lead-out parts 121a and 122a are not overlapped with each other but exposed to the second and first side surfaces of the ceramic body, respectively, such that the overlapping region, the capacitance formation part 120 of the first and second internal electrodes 121 and 122, may be increased, thereby increasing capacitance of the multi-layered ceramic capacitor.

Referring to FIG. 5, when a length of the ceramic body 110 in the length direction is defined as L, and a width of a margin part, that is, a region in which the internal electrode is not formed, in the length direction of the ceramic body 110 is defined as Lm, 0.03≦Lm/L≦0.2 may be satisfied.

As described above, the length L of the ceramic body 110 in the length direction and the width Lm of the margin part, that is, the region in which the internal electrode is not formed, in the length direction of the ceramic body 110 are adjusted so that 0.03≦Lm/L≦0.2 is satisfied, whereby capacitance may be increased and reliability may be improved.

In the case in which Lm/L is below 0.03, step stress may be concentrated on a narrow area to weaken interlayer adhesion, such that reliability may be deteriorated due to crack defect.

In the case in which Lm/L is above 0.2, a ratio of capacitance to target capacitance may be reduced to be below 95%.

In addition, when the length of the ceramic body 110 in the length direction is defined as L, and a length of the non-overlapping region in the length direction of the ceramic body 110 is defined as Lc, 0.05≦Lc/L≦0.4 may be satisfied.

As described above, the length L of the ceramic body 110 in the length direction and the length Lc of the non-overlapping region in the length direction of the ceramic body 110 are adjusted so that 0.05≦Lc/L≦0.4 is satisfied, whereby contact strength with the external electrode may be improved, and the generation of short circuit defects due to a moisture-resistance defect may be blocked.

In the case in which Lc/L is below 0.05, since a contact area with the external electrode is reduced, the contact strength with the external electrode may be reduced.

In the case in which Lc/L is above 0.4, the short circuit defects may be generated due to the moisture-resistance defect.

In addition, when a width of the ceramic body 110 in the width direction is defined as W, and a width of the non-overlapping region in the width direction of the ceramic body 110 is defined as Wc, 0.05≦Wc/W≦0.5 may be satisfied.

As described above, the width W of the ceramic body 110 in the width direction and the width Wc of the non-overlapping region in the width direction of the ceramic body 110 are adjusted so that 0.05≦Wc/W≦0.5 is satisfied, whereby capacitance may be increased, and reliability may be improved.

In the case in which Wc/W is below 0.05, reliability may be deteriorated due to a crack defect caused by the step.

In the case in which Wc/W is above 0.5, a ratio of capacitance to target capacitance may be reduced to be below 95%.

Referring to FIGS. 3 through 5, the first external electrode 131 may be formed so as to be connected to the first lead-out part 121a of the first internal electrode 121 led to the second side surface 2 of the ceramic body 110, and the second external electrode 132 may be formed so as to be connected to the second lead-out part 122a of the second internal electrode 122 led to the first side surface 1 of the ceramic body 110.

The first external electrode 131 may be formed on the second side surface 2 of the ceramic body so as to be connected to the first lead-out part 121a and may be extended to the first main surface 5 of the ceramic body, but is not limited thereto.

The second external electrode 132 may be formed on the first side surface 1 of the ceramic body so as to be connected to the second lead-out part 122a and may be extended to the first main surface 5 of the ceramic body, but is not limited thereto.

That is, the first external electrode 131 may be extended to at least one of the first main surface 5, the second main surface 6, and the first side surface 1 of the ceramic body 110.

In addition, the second external electrode 132 may be extended to at least one of the first main surface 5, the second main surface 6, and the second side surface 2 of the ceramic body 110.

Therefore, according to the embodiment of the present invention, the first external electrode 131 may enclose one end portion of the ceramic body 110 in the length direction while being connected to the first lead-out part 121a of the first internal electrode 121 exposed to the second side surface 2 of the ceramic body 110.

In addition, the second external electrode 132 may enclose the other end portion of the ceramic body 110 in the length direction while being connected to the second lead-out part 122a of the second internal electrode 122 exposed to the first side surface 1 of the ceramic body 110.

The first and second external electrodes 131 and 132 may be formed of a conductive paste including a conductive metal.

The conductive metal may be nickel (Ni), copper (Cu), tin (Sn), or an alloy thereof, but is not limited thereto.

The conductive paste may further include an insulating material. The insulating material may be, for example, glass, but is not limited thereto.

A method of forming the first and second external electrodes 131 and 132 is not particularly limited. That is, the first and second external electrodes 131 and 132 may be formed by dipping the ceramic body in a conductive material or may be formed by a method such as a plating method, or the like.

Meanwhile, according to the embodiment of the present invention, as shown in FIG. 5, the insulation layers 140 may be formed on the first and second side surfaces 1 and 2 of the ceramic body 110.

The insulation layer 140 may be formed between the first and second external electrodes 131 and 132.

The insulation layer 140 may cover the entirety of an overlapping portion of the first and second internal electrodes 121 and 122.

According to the embodiment of the present invention, as shown in FIG. 5, the insulation layer 140 may entirely cover one surface of the ceramic body between the first and second external electrodes.

According to the embodiment of the present invention, the insulation layer 140 may have a height lower than that of the first external electrode 131 or the second external electrode 132. The heights of the insulation layer and the external electrode may be measured based on a mounting surface, that is, the first main surface.

According to the embodiment of the present invention, the insulation layer has a height lower than those of the first and second external electrodes, such that the multi-layered ceramic capacitor 100 may be more stably mounted on the circuit board.

In addition, the first and second external electrodes 131 and 132 may be formed on portions of the first and second side surfaces of the ceramic body.

The insulation layer 140 may include at least one selected from a group consisting of, for example, an epoxy, a heat resistant polymer, glass, and a ceramic, but is not particularly limited thereto.

According to the embodiment of the present invention, the insulation layer 140 may be formed of ceramic slurry.

A formation position and the height of the insulation layer 140 may be adjusted by adjusting an amount and a shape of the ceramic slurry.

The insulation layer 140 may be formed by applying ceramic slurry to the ceramic body formed by a firing process and then firing the ceramic slurry.

Alternatively, the insulation layer 140 may be formed by forming ceramic slurry configuring the insulation layer on a ceramic green sheet configuring the ceramic body and then firing the ceramic slurry together with the ceramic green sheet.

A method of forming the ceramic slurry is not particularly limited. For example, the ceramic slurry may be coated by a spraying method or may be applied using a roller.

The insulation layer 140 covers the first and second lead-out parts 121a and 122a exposed to one surface of the ceramic body, whereby short circuit defects between the internal electrodes may be prevented, and an internal defect such as a deterioration in moisture resistance characteristics, or the like, may be prevented.

A multi-layered ceramic electronic component according to another embodiment of the present invention may include a ceramic body 110 including a dielectric layer 111 and having first and second main surfaces 5 and 6 opposing each other, first and second side surfaces 1 and 2 opposing each other, and first and second end surfaces 3 and 4 opposing each other; a first internal electrode 121 having an overlapping region provided in the ceramic body 110 so as to form a capacitance part 120 forming capacitance, exposed to the first and second side surfaces 1 and 2, and spaced apart from the first and second end surfaces 3 and 4 by a predetermined interval, and including a first lead-out part 121a extended from the capacitance part 120 so as to be exposed to the second side surface 2; a second internal electrode 122 alternately multi-layered with the first internal electrode 121, having the dielectric layer 111 therebetween, exposed to the first and second side surfaces 1 and 2, spaced apart from the first and second end surfaces 3 and 4 by a predetermined interval, insulated from the first internal electrode 121, and including a second lead-out part 122a extended from the capacitance part 120 so as to be exposed to the first side surface 1; a first external electrode 131 connected to the first lead-out part 121a and formed on the first main surface 5 and the second side surface 2 and a second external electrode 132 connected to the second lead-out part 122a and formed on the first main surface 5 and the first side surface 1; and insulation layers 140 formed on the first and second side surfaces 1 and 2 of the ceramic body 110, wherein the first and second lead-out parts 121a and 122a may be regions in which the first and second internal electrodes 121 and 122 are not overlapped with each other.

When a length of the ceramic body in the length direction is defined as L, and a width of a margin part, that is, a region in which the internal electrode is not formed, in the length direction of the ceramic body is defined as Lm; may be satisfied.

When the length of the ceramic body in the length direction is defined as L, and a length of the non-overlapping region in the length direction of the ceramic body is defined as Lc; 0.05≦Lc/L≦0.4 may be satisfied.

When a width of the ceramic body in the width direction is defined as W, and a width of the non-overlapping region in the width direction of the ceramic body is defined as Wc, 0.05≦Wc/W≦0.5 may be satisfied.

The insulation layer may include at least one selected from a group consisting of an epoxy, a heat resistant polymer, glass, and a ceramic.

The insulation layer may be formed to cover the entirety of the exposed portions of the first and second internal electrodes overlapped with each other.

The insulation layer may be less thick than the first and second external electrodes measured from the first side surface of the ceramic body 110.

Hereinafter, components different from those of the embodiment of the present invention described above may be mainly described and a detailed description of the same component will be omitted.

The multi-layered ceramic capacitor 100 according to another embodiment of the present invention may include the first internal electrode 121 having the overlapping region provided in the ceramic body 110 so as to form the capacitance part 120 forming capacitance, exposed to the first and second side surfaces 1 and 2, and spaced apart from the first and second end surfaces 3 and 4 by the predetermined interval, and including the first lead-out part 121a extended from the capacitance part 120 so as to be exposed to the second side surface 2; and the second internal electrode 122 alternately multi-layered with the first internal electrode 121, having the dielectric layer 111 therebetween, exposed to the first and second side surfaces 1 and 2, spaced apart from the first and second end surfaces 3 and 4 by a predetermined interval, insulated from the first internal electrode 121, and including a second lead-out part 122a extended from the capacitance part 120 so as to be exposed to the first side surface 1.

In addition, the multi-layered ceramic capacitor 100 may include the first external electrode connected to the first lead-out part 121a and formed on the first main surface 5 and the second side surface 2, and the second external electrode 132 connected to the second lead-out part 122a and formed on the first main surface 5 and the first side surface 1.

According to another embodiment of the present invention, the lead-out part of the internal electrode refers to a region in which a conductor pattern forming the internal electrode has an increased width W to thereby be exposed to one surface of the ceramic body.

Generally, the first and second internal electrodes may form capacitance in an overlapping region thereof, and the lead-out parts connected to the external electrodes having different polarities do not have an overlapping region.

According to the embodiment of the present invention, the overlapping region fainting the capacitance part 120 may be exposed to the first and second side surfaces 1 and 2, the first internal electrode 121 may have the first lead-out part 123a extended from the capacitance part 120 so as to be exposed to the second side surface 2, and the second internal electrode 122 may have the second lead-out part 122a extended from the capacitance part 120 so as to be exposed to the first side surface 1.

The first and second lead-out parts 121a and 122a are not overlapped with each other, such that the first and second internal electrodes 121 and 122 may be insulated from each other.

As described above, according to the embodiment of the present invention, the overlapping region forming the capacitance part 120 is formed in the ceramic body 110 so as to be exposed to the first and second side surfaces 1 and 2, whereby capacitance of the multi-layered ceramic capacitor 100 may be increased.

In addition, a distance between the first and second internal electrodes to which external voltages having different polarities are applied is reduced, such that a current loop may be shortened. Therefore, equivalent series inductance (ESL) may be decreased.

The following Table 1 is a table in which whether or not a crack is generated, whether or not short circuit defects are generated, and whether or not capacitance is secured based on the target capacitance are compared in the multi-layered ceramic capacitor according to the embodiment of the present invention, according to the length L of the ceramic body 110 in the length direction, the width Lm of the margin part, that is, the region in which the internal electrode is not formed in the length direction of the ceramic body 110, the length Lc of the non-overlapping region in the length direction of the ceramic body 110, the width W of the ceramic body 110 in the width direction, and the width We of the non-overlapping region in the width direction of the ceramic body 110.

Here, whether or not a crack was generated is represented by “◯” when the number of samples in which a crack was generated among 200 samples was less than 6, and represented by “×” when the number of samples in which a crack was generated was 6 or more.

In addition, whether or not a short circuit was generated is represented by “◯” when a ratio of the sample in which a crack was generated to the 200 samples was 20% or less, and represented by “×” when the ratio was more than 20%.

Further, whether or not capacitance was secured, based on the target capacitance, is represented by “◯” when a ratio of capacitance to target capacitance was 95% or more.

TABLE 1

| | | | | Whether | Whether or not | |
|---|---|---|---|---|---|---|
| | | | | or not | short circuit | |
| | | | | crack was | defect was | |
| | Lm/L | Lc/L | Wc/W | generated | generated | Capacitance |
| *1 | 0.01 | 0.05 | 0.05 | X | X | ◯ |
| 2 | 0.03 | 0.05 | 0.05 | ◯ | ◯ | ◯ |
| *3 | 0.03 | 0.01 | 0.05 | ◯ | ◯ | X |
| 4 | 0.03 | 0.03 | 0.05 | ◯ | ◯ | X |
| 5 | 0.03 | 0.1 | 0.05 | ◯ | ◯ | ◯ |
| 6 | 0.03 | 0.2 | 0.05 | ◯ | ◯ | ◯ |
| 7 | 0.03 | 0.3 | 0.05 | ◯ | ◯ | ◯ |
| *8 | 0.03 | 0.5 | 0.05 | ◯ | X | ◯ |
| *9 | 0.03 | 0.05 | 0.01 | X | X | ◯ |
| *10 | 0.03 | 0.05 | 0.03 | X | X | ◯ |
| 11 | 0.03 | 0.05 | 0.1 | ◯ | ◯ | ◯ |
| 12 | 0.03 | 0.05 | 0.2 | ◯ | ◯ | ◯ |
| 13 | 0.03 | 0.05 | 0.3 | ◯ | ◯ | ◯ |
| *14 | 0.03 | 0.05 | 0.6 | ◯ | ◯ | X |
| 15 | 0.1 | 0.05 | 0.05 | ◯ | ◯ | ◯ |
| *16 | 0.3 | 0.5 | 0.6 | ◯ | ◯ | X |

*Comparative Example

Referring to Table 1, it may be appreciated that in the multi-layered ceramic capacitor according to the embodiment of the present invention, in the cases of samples 1, 3, 8 to 10, 14, and 16, outside of the numerical range of the present invention, there are problems in that defects due to the cracks and the short circuits were generated or capacitance was reduced as compared to the target capacitance.

On the other hand, it may be appreciated that in the cases of samples 2, 4 to 7, 11 to 13, and 15 that satisfy the numerical range according to the embodiment of the present invention, the generation of cracks and the short circuits was reduced, such that reliability was excellent and the capacitance was increased.

As set forth above, according to the embodiment of the present invention, the first and second internal electrodes are exposed to the first and second side surfaces of the ceramic body, respectively, such that step sections formed in two directions in the related may be changed to step sections formed in one direction, thereby reducing short circuit defects between the internal electrodes.

According to the embodiment of the present invention, the overlapping region forming the capacitance part between the first and second internal electrodes is increased, whereby capacitance of the multi-layered ceramic capacitor may be increased.

In addition, a distance between the first and second internal electrodes to which external voltages having different polarities are applied is reduced, such that a current loop may be shortened. Therefore, equivalent series inductance (ESL) may be decreased.

Further, with the multi-layered ceramic capacitor according to the embodiment of the present invention, a mounting area provided on a printed circuit board may be significantly reduced and acoustic noise may be significantly reduced.

While the present invention has been shown and described in connection with the embodiments, it will be apparent to those skilled in the art that modifications and variations can be made without departing from the spirit and scope of the invention as defined by the appended claims.

That is claimed is:

1. A multi-layered ceramic electronic component comprising:
a ceramic body including a dielectric layer and having first and second main surfaces opposing each other, first and second side surfaces opposing each other, and first and second end surfaces opposing each other;
a first internal electrode having an overlapping region provided in the ceramic body so as to form a capacitance formation part and exposed to the first and second side surfaces, and including a first lead-out part extended from the capacitance part so as to be exposed to the second side surface;
a second internal electrode alternately multi-layered with the first internal electrode so as to be exposed to the first and second side surfaces, having the dielectric layer therebetween, and insulated from the first internal electrode, and including the second lead-out part extended from the capacitance part so as to be exposed to the first side surface;
first and second external electrodes connected to the first and second lead-out parts, respectively; and
insulation layers formed on the first and second side surfaces of the ceramic body,
the first and second lead-out parts being regions in which the first and second internal electrodes are not overlapped with each other.

2. The multi-layered ceramic electronic component of claim 1, wherein when a length of the ceramic body in a length direction is defined as L, and a width of a margin part corresponding to a region in which the internal electrode is not formed, in the length direction of the ceramic body is defined as Lm, 0.03≦Lm/L≦0.2 is satisfied.

3. The multi-layered ceramic electronic component of claim 1, wherein when a length of the ceramic body in the length direction is defined as L, and a length of a non-overlapping region in the length direction of the ceramic body is defined as Lc, 0.05≦Lc/L≦0.4 is satisfied.

4. The multi-layered ceramic electronic component of claim 1, wherein when a width of the ceramic body in a width direction is defined as W, and a width of a non-overlapping region in the width direction of the ceramic body is defined as Wc, 0.05≦Wc/W≦0.5 is satisfied.

5. The multi-layered ceramic electronic component of claim 1, wherein the first external electrode is extended to at least one of the first main surface, the second main surface, and the first side surface of the ceramic body.

6. The multi-layered ceramic electronic component of claim 1, wherein the second external electrode is extended to at least one of the first main surface, the second main surface, and the second side surface of the ceramic body.

7. The multi-layered ceramic electronic component of claim 1, wherein the insulation layer includes at least one selected from a group consisting of an epoxy, a heat resistant polymer, glass, and a ceramic.

8. The multi-layered ceramic electronic component of claim 1, wherein the insulation layer covers the entire exposed portions of the first and second internal electrodes.

9. The multi-layered ceramic electronic component of claim 1, wherein the insulation layer has a thickness lower than that of the second external electrode measured from the first side surface of the ceramic body and that of the first external electrode measured from the second side surface.

10. A multi-layered ceramic electronic component comprising:
a ceramic body including a dielectric layer and having first and second main surfaces opposing each other, first and second side surfaces opposing each other, and first and second end surfaces opposing each other;
a first internal electrode having an overlapping region provided in the ceramic body so as to form a capacitance formation part, exposed to the first and second side surfaces, and spaced apart from the first and second end surfaces by a predetermined interval, and including a first lead-out part extended from the capacitance part so as to be exposed to the second side surface;
a second internal electrode alternately multi-layered with the first internal electrode, having the dielectric layer therebetween, exposed to the first and second side surfaces, spaced apart from the first and second end surfaces by a predetermined interval, and insulated from the first internal electrode, and including a second lead-out part extended from the capacitance part so as to be exposed to the first side surface;
a first external electrode connected to the first lead-out part and formed on the first main surface and the second side surface and a second external electrode connected to the second lead-out part and formed on the first main surface and the first side surface; and
insulation layers formed on the first and second side surfaces of the ceramic body,
the first and second lead-out parts being regions in which the first and second internal electrodes are not overlapped with each other.

11. The multi-layered ceramic electronic component of claim 10, wherein when a length of the ceramic body in a length direction is defined as L, and a width of a margin part corresponding to a region in which the internal electrode is not formed, in the length direction of the ceramic body is defined as Lm, 0.03≦Lm/L≦0.2 is satisfied.

12. The multi-layered ceramic electronic component of claim 10, wherein when a length of the ceramic body in the length direction is defined as L, and a length of a non-overlapping region in the length direction of the ceramic body is defined as Lc, 0.05≦Lc/L≦0.4 is satisfied.

13. The multi-layered ceramic electronic component of claim 10, wherein when a width of the ceramic body in a width direction is defined as W, and a width of a non-overlapping region in the width direction of the ceramic body is defined as Wc, 0.05≦Wc/W≦0.5 is satisfied.

14. The multi-layered ceramic electronic component of claim 10, wherein the insulation layer includes at least one selected from a group consisting of an epoxy, a heat resistant polymer, glass, and a ceramic.

15. The multi-layered ceramic electronic component of claim 10, wherein the insulation layer covers the entire exposed portions of the first and second internal electrodes.

16. The multi-layered ceramic electronic component of claim 10, wherein the insulation layer has a thickness lower than that of the second external electrode measured from the first side surface of the ceramic body and that of the first external electrode measured from the second side surface of the ceramic body.
